(19) United States
(12) Patent Application Publication
(10) Pub. No.: US 2021/0063142 A1
(43) Pub. Date: Mar. 4, 2021

(54) Method and Device for Detecting the Position of a Seal

(71) Applicants: ATN Hölzel GmbH, Oppach (DE); Bayerische Motoren Werke Aktiengesellschaft, München (DE)

(72) Inventors: Philipp Rudolf, Beiersdorf (DE); Lukas Langgärtner, München (DE); Alexander Laudan, München (DE)

(21) Appl. No.: 16/962,230

(22) PCT Filed: Jan. 17, 2019
(86) PCT No.: PCT/DE2019/100046

§ 371 Date: Jul. 15, 2020

(30) Foreign Application Priority Data
Jan. 19, 2018 (DE) 10 2018 101 248.9
Apr. 27, 2018 (DE) 10 2018 110 303.4

(51) Int. Cl. G01B 11/245; B60J 10/00

(52) U.S. Cl. CPC G01B 11/245; B60J 10/45

(57) ABSTRACT

A method for automated position sensing of a seal relative to a component or at least one component region during or after automated application of the seal, wherein the relative position of the seal to the component or to the at least one component region is sensed by means of at least one sensor. There is also a device for performing the method, wherein the at least one sensor is arranged such that its main sensing direction is oriented to be perpendicular to the running direction of the seal or of the component or of the at least one component region or to deviate from it at an angle of up to 45 degrees and the at least one sensor with a sensing range senses the seal and/or the component or the at least one component region.

### CROSS REFERENCE TO RELATED APPLICATIONS

This application is the U.S. national stage of International Application No. PCT/DE2019/100046, filed on 2019 Jan. 17. The international application claims the priority of DE 102018101248.9 filed on 2018 Jan. 19 and the priority of DE 102018110303.4 filed on 2018 Apr. 27; all applications are incorporated by reference herein in their entirety.

### BACKGROUND

Method and device for sensing the position of a seal, specifically a door seal on a component, specifically on a vehicle.

The position sensing as described here relates specifically to adhesively bonded profile seals or door seals as well as to seals on a door flange, including position sensing of other or further seals on other components or surfaces.

The position sensing according to the invention allows seals applied to the respective component in an automated, manual or other manner to be inspected. Accordingly, universal application is possible. Therefore, this includes seals which are to be applied independently of each other to vehicle body openings such as hatchback doors, trunk lids, trunk doors or windows as well as to their specific constructive design with flange, folded seam or surface. Furthermore, the seals may be circumferential or partially circumferential seals or door seals or regions of seals.

The problem with profile seals, specifically on a vehicle, is that, if faultily applied or applied exceeding the specified tolerance, they may be excessively stressed and pinched, on the one hand, leading to premature ageing or wear or destruction and making the fitting of the door or even use of the door impossible or considerably more difficult. On the other hand, the seal does not fulfil its intended purpose since gaps may form, which lead to increased background noise in the vehicle or allow ingress of moisture, each of which must be avoided.

As a result of faulty application or application exceeding the specified tolerance, rework must be done, which is costly and time-consuming, resulting in considerable delays in an automated manufacturing process since any rework is manual if necessary.

Since there are also component tolerances, any evaluation of the seal position with respect to the seal tolerances must be performed during application on the component in consideration of the component tolerances.

At present, the seal position is manually realised by means of a vernier calliper, a steel ruler or templates. Other methods measure in dimensionally unstable regions. The present quality controls are performed manually and only as spot checks at few locations. This is time-consuming since the components must be removed from an automated process and re-introduced after a positive check.

Furthermore, the seals are presently applied with the component tolerances being considered only to a limited extent. Hence, components are fitted with a seal with an out-of-tolerance application of the seal, this possibly not being caused by the seal application but by the component, which is found out only after the downstream position check.

### SUMMARY

The object of the invention is therefore to create a method and device for automated seal position sensing capable of sensing also the component tolerances in addition to the seal position on the respective component, enabling quality evaluation based on the sensed position and component tolerances.

Besides sequential checking, it is intended to enable uninterrupted position sensing and quality checking.

The object is achieved by the characteristics of the independent claim. Furthermore, the object is achieved by implementing the characteristics of the additional independent claim.

A method for automated position sensing of a seal (1) relative to a component (2) or at least one component region (2) during or after automated application of the seal (1), wherein the relative position of the seal (1) to the component (2) or to the at least one component region (2) is sensed by means of at least one sensor (3).

A device for performing the method for automated position sensing of a circumferential or sectionally running seal (1) by means of at least one sensor (3) relative to a component (2) or to at least one component region (2) during or after application of the seal (1), wherein the least one sensor (3) is arranged such that its main sensing direction (6) is oriented to be perpendicular to the running direction (7) of the seal (1) or of the component (2) or of the at least one component region (2) or to deviate from it at an angle of up to 45 degrees and the at least one sensor (3) with a sensing range (8) senses the seal (1) and/or the component (2) or the at least one component region (2).

### DETAILED DESCRIPTION

The underlying solution describes a measuring method which allows the seal position to be measured during application of a door seal, specifically in an automated process. This means that the position sensing measurement is continuous and thus also simultaneous, either on its own or already during the application process. However, this measurement can also be made sequentially, i.e. only at specified points if required by the process. In this measurement, the dimensionally stable section of the seal, for example the seal foot, is to be used as a reference point. For measuring the seal position, features of the component such as a door, i.e. contours or spatial and/or planar features, are intended to be used. This is to ensure that a relative determination of the seal position is made possible.

In the method for automated position sensing of a seal relative to a component or at least one component region, the relative position of the seal is sensed by at least one sensor on the basis of the component or the at least one component region during or after the automated application of the seal.

For this purpose, a device for performing the method for automated position sensing of a circumferential or sectionally running seal is used, using at least one sensor with one sensing range to sense the seal during or after its application relative to a component or at least one component region and/or the component or the at least one component region, wherein the at least one sensor is arranged such that it main sensing direction is oriented to be perpendicular to the running direction of the seal or of the component or of the at least one component region or to deviate from a perpendicular arrangement at an angle of up to 45 degrees. Depending on the type of sensor, the sensing range is fan-shaped or cone-shaped, flaring out from the sensor such that it senses a wide planar and also a spatial region, depending on the seal or component.

In a preferred embodiment of the device, two sensors are used. This is necessary depending on the seal and/or component since shadowing effects may occur, resulting accordingly from the constructive design of the seal or component. If, however, simple or only slightly curved seals or only slightly curved or non-curved components are used in the application and position monitoring of the seal, only one sensor can be used.

Besides the field of application shown, there is the possibility of application in other plants where the seal is applied automatedly and which need the use of reliable position sensing.

The advantage is the full inspection of the components. Currently, only random inspections are performed, or faulty application is noticed in the so-called water test or when the respective component, e.g. a vehicle door, is mounted. As a consequence, the component in question, such as the respective vehicle door, needs to be dismounted, the seal to be removed, a new seal to be applied and the component, e.g. the respective vehicle door, to be re-mounted. The burden for correcting a faulty door is about 50 min of rework. Using the above invention can shorten this time to 5 min since it is possible to react directly after application and to rework the seal immediately in the process, e.g. by manual rework or re-introduction into the automatic process.

A further advantage is that the method may also be used before application in order to measure the component, thereby performing a position correction which influences the subsequent seal application process.

Advantageous embodiments of the method and device are presented in the dependent claims.

By sensing the seal position detection relative to least one geometry of the component or at least one region of the component, more precise position sensing and thus seal application is achieved. This allows an overall assessment as well as a detailed assessment with regard to the construction design of the component or respective region of the component, making the seal position sensing more reliable and precise.

In an improved embodiment, spatial and/or planar features of the component or component region are sensed, making the position sensing more precise since the position sensing also relies on the sensing of various or further parameters of the component or component region and additionally senses component tolerances, which can immediately be taken into account or result in discarding the component.

Furthermore, spatial and/or planar features of the seal are sensed at least in some regions, making the position sensing also more precise since various or further seal parameters are sensed for the position sensing, whereby also tolerances of shape or other deviations are sensed besides the sensing of the specific position and can be fed into the application process.

Spatial and/or planar features include holes, recesses, indents, marks or colouring as well as bends or steps or edges, for example.

The contour, too, is understood to be among the spatial and/or planar features.

Advantageously, the seal is sensed in a dimensionally stable region. In this way, measurement errors can largely be avoided or at least reduced since the dimensionally stable region is hardly or not at all subject to changes by deformation during application, and thus there are largely standardized starting points or reference points based on this dimensionally stable region and for each measurement.

By changing the cross-section of the seal, specifically of the flexible profile of this seal, the reliability of the measurement increases since, on the one hand, defined and uniform cross-sections are created for the measurement and, on the other hand, shadowing caused by the flexible profile sections is eliminated or the dimensionally stable region is temporarily exposed for the measurement.

In an improved embodiment, position sensing is simultaneous, either circumferential or pointwise, ensuring that the position of the door seal is determined directly and at very small measuring distances. This embodiment measures the position of the door seal in-line, i.e. during application. A measurement result can be output, which can be narrowed down by parameters and a result in the sense of pass or fail can be output.

Already during seal application, measuring simultaneously allows the ongoing application to be corrected. Moreover, already before application, the component or component region can be measured and thus a positional correction can be performed, which influences and favours the subsequent seal application process.

Additionally, position sensing is performed as a distance measurement, improving the position sensing and making it more accurate.

By sensing the position using a triangulation method, runs and regions as well as positions of the seal or component or component region for any contour or surface profiles can be sensed more precisely.

With two or more sensors of at least two sensors, having the respective sensing ranges arranged in one plane allows complex or extended or curved or otherwise spatially shaped geometries to be sensed more reliably since a standardized or coherent measurement as well as a standardized or coherent result are made possible, which improves the quality of the measurement or position sensing. This avoids distortions in the result, which may be produced by different measuring points on different planes.

An improved embodiment that has two or more sensors along the running direction of the seal or of the component or of the at least one component region arranged in an offset manner allows sensing also longitudinally extended runs and any deviations or distortions contained in them.

With two or more sensors, having at least two sensors in a laterally offset arrangement relative to each other, curved or otherwise spatially shaped geometries can also be sensed more reliably, allowing a standardized or coherent measurement as well as a standardized or coherent result, which improves the quality of the measurement or position sensing.

Having the main sensing directions or sensing ranges of the at least two sensors oriented in parallel or at an angle of 1 to 90 degrees, preferably 50 to 70 degrees, relative to each other reliably ensures that particular spatial or angled geometries, and thus the position of the seal relative to the component or component region, are also reliably sensed. In this way, the spatial and planar features as well as the geometry of the component and, if relevant, of the seal predetermine the angle at which the main sensing directions are oriented or are to be oriented relative to each other in order to sense the respective spatial and planar features as well as the respective geometry reliably.

The sensors being oriented towards the dimensionally stable region of the seal and/or spatial and/or planar features of the component or of the at least one component region ensure that the sensors are oriented towards and sense largely standardized starting points or reference points so that position sensing and its evaluation is facilitated. Any dynamic adjustment to continuously changing geometries can thus be reduced or avoided.

In the improved embodiment having sensors that are movable in place or can be guided around the component or component region, the flexibility of the device for different automation solutions is increased. It is thus also possible to monitor the application of the seal onto stationary or moving components or to sense the seal position.

Overlapping or overlying sensing directions of at least two sensors allow the sensing ranges of the individual sensors to be combined or to be grouped by different perspectives, whereby complex spatial regions can also be sensed besides extended planar regions.

Different exemplary embodiments of the invention are described in greater detail below.

### BRIEF DESCRIPTION OF THE DRAWINGS

Of the drawings:

FIG. 1 shows a vehicle door as a component with a circumferential seal and a device with two sensors as fan-type sensors, which are positioned in one plane in a laterally offset manner, sensing the seal laterally and the respective component regions laterally adjacent to the seal.

FIG. 2 shows a detail section of FIG. 1,

FIG. 3 shows a sectional view of a region of a vehicle door as a component with a circumferential seal and a device with two sensors, which are positioned in one plane in a laterally offset manner, sensing the seal laterally and the respective component regions laterally adjacent to the seal,

FIG. 4 shows a sectional view of a region of a vehicle door as a component with a circumferential seal and a device with two sensors,

FIGS. 5 and 6 show a detail view of a sectional view of a component with a seal and the sensing ranges of two sensors in different perspectives, which sensors are positioned in one plane in a laterally offset manner, sensing the seal laterally and the respective component regions laterally adjacent to the seal with the spatial, planar features of the seal and of the component.

FIG. 7 shows a detail view of a component region as a sectional view, and

FIG. 8 shows a detail view of a region of a vehicle door as a component without seal and a device with two sensors, arranged in different perspectives.

### DETAILED DESCRIPTION OF THE PREFERRED EMBODIMENTS

In the method for automated position sensing of a seal 1 relative to a component 2 or at least a component region 2 according to the invention provides for sensing of the relative position of the seal 1 to the component 2 or to the at least one component region 2 by at least one sensor 3 during or after automated application of the seal 2.

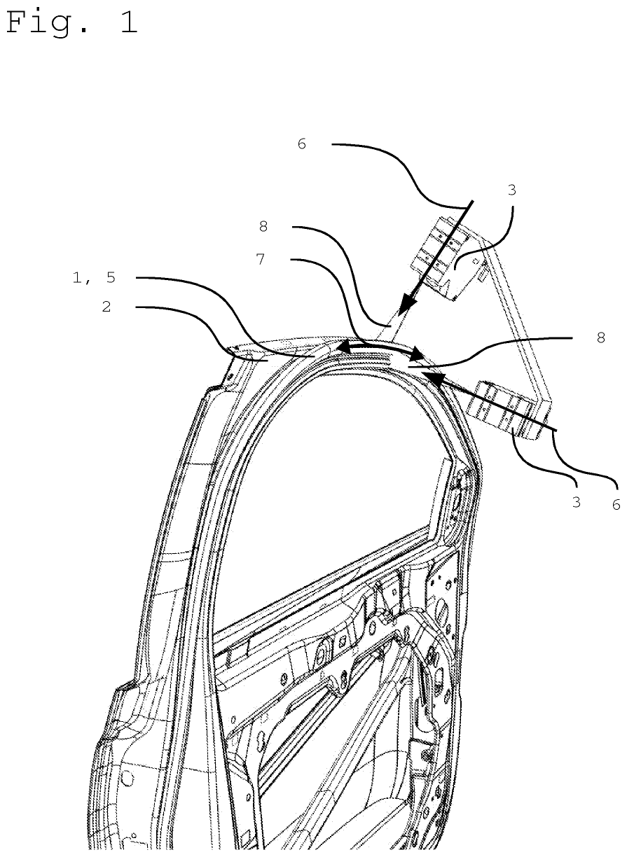

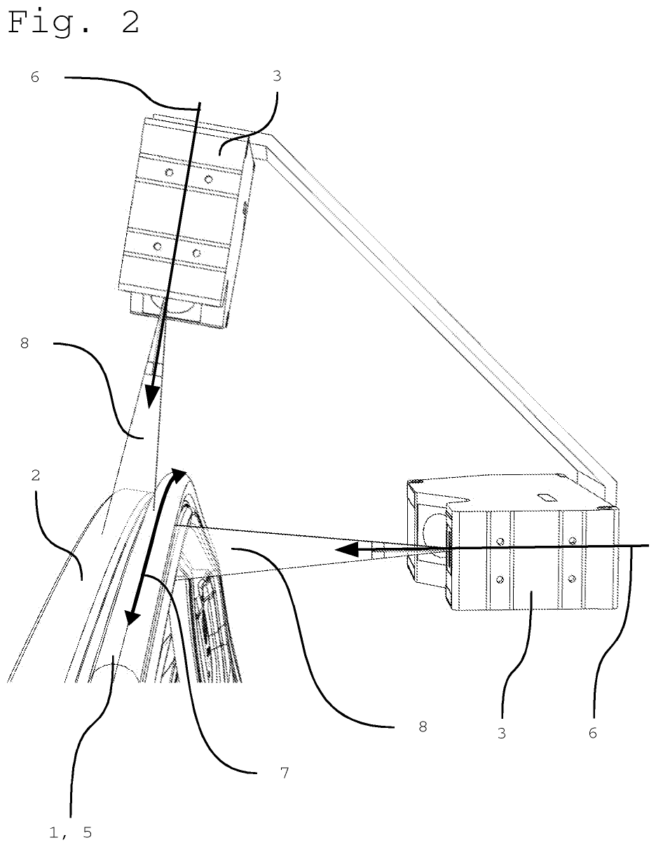

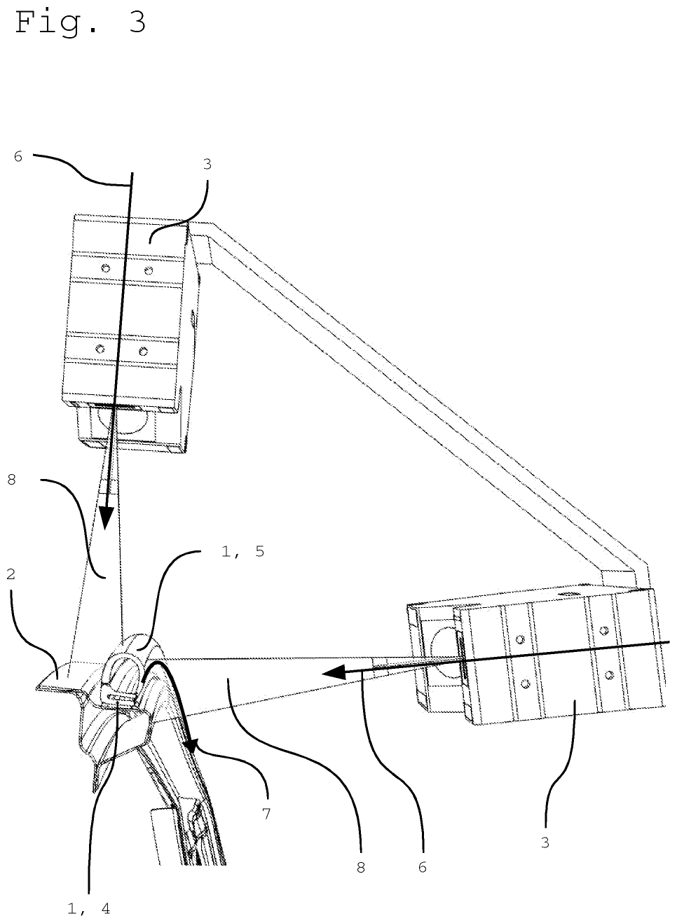

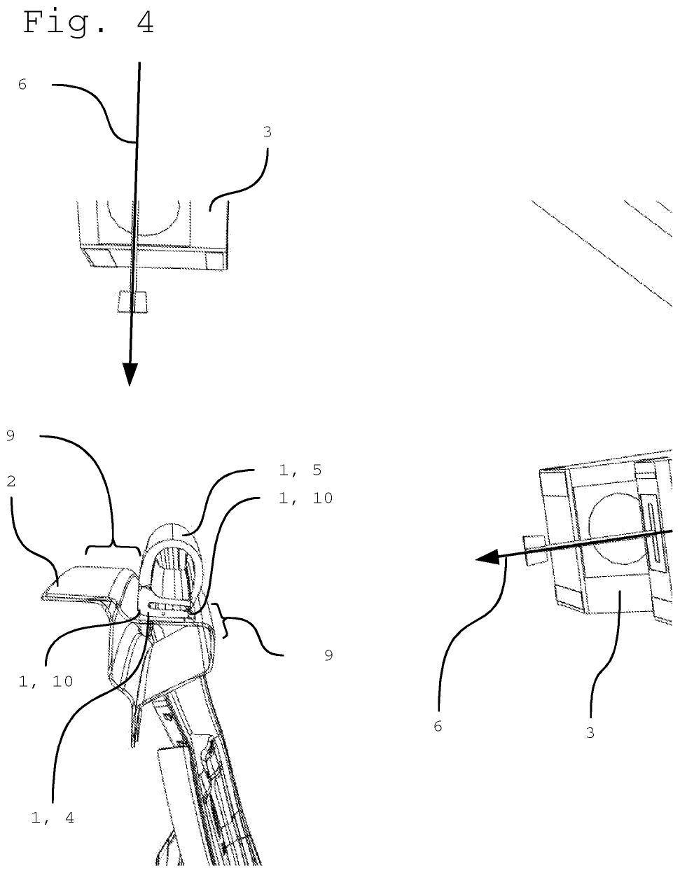

Therein, the position of the seal 1 is sensed relative to the geometry of the component 2 or the at least one component region 2. For this purpose, spatial and planar features 9 of the component 2 or the at least one component region 2 are sensed as shown in FIGS. 1 to 6. Folded seams, steps or curvatures or changes in the course or changes in the direction of the contour are considered in the sensing. These spatial and/or planar features 10 of the seal 1 are sensed at least in some regions. In particular, the seal 1, which is strongly compressed during application, introduces a potential inaccuracy, among other things. To exclude shape deviations, the seal 1 is sensed in a dimensionally stable region 4. This is e.g. the seal foot 4 which is adhesively bonded to the component 2 such as a vehicle door or to a respective component region 2 by means of an adhesive or by means of a double-sided adhesive tape and must therefore not warp during application, and is thus a suitable measuring or position sensing reference point.

In order to adjust the seal 1, which may have any cross-sections, for position sensing in addition to the sensing of the seal foot 4 as a dimensionally stable region 4, a change in the cross-section of the seal 1, specifically of the flexible profile 5 of this seal 1, i.e. above the seal foot 4, is intended. This can involve compressing it to obtain a very narrow cross-section or pushing it sidewards in order to hold the seal foot 4 exposed or to expose it for position sensing.

Position sensing is simultaneous, either circumferential or pointwise. This allows position sensing that is permanent, performed at given points or performed irregularly. Depending on the type of application, the component 2 with the run of the applied seal 1 is guided along the at least one sensor 3 or the at least one sensor 3 is guided along the applied seal 1. This is preferably done by a robot.

Position sensing is performed as a distance measurement, preferably by means of at least one fan-type sensor or light section sensor, the position sensing being thus performed as a triangulation process.

To improve the method, two sensors 3 are used, with the sensors 3 sensing the seal 1 from both sides in an offset arrangement relative to each other. This allows sensing the component 2 or component region 2 on both sides of the seal 1. Position sensing is thus performed based on two component regions 2, each based on the side of the seal 1 and on the seal 1. In this manner, the dimensionally stable region 4 is sensed on both sides of the seal 1.

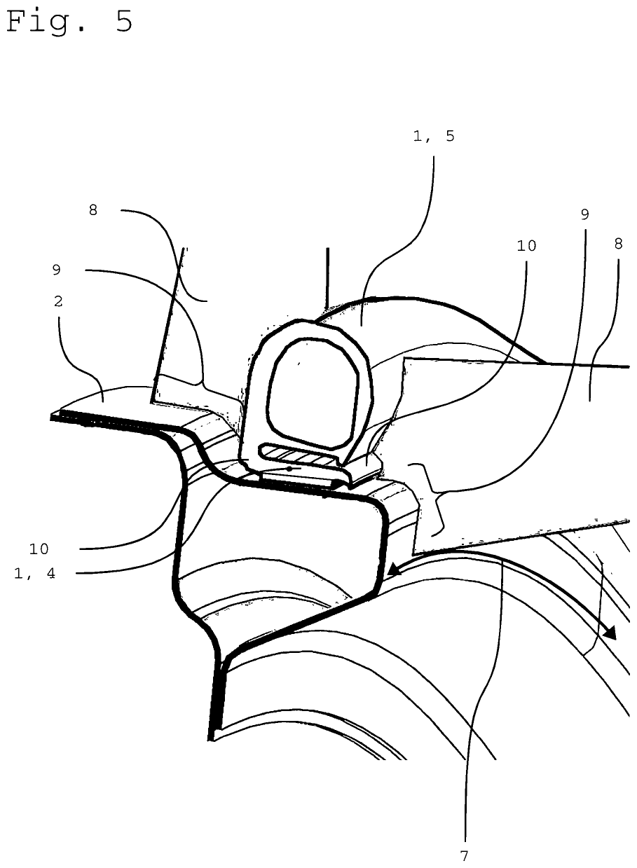

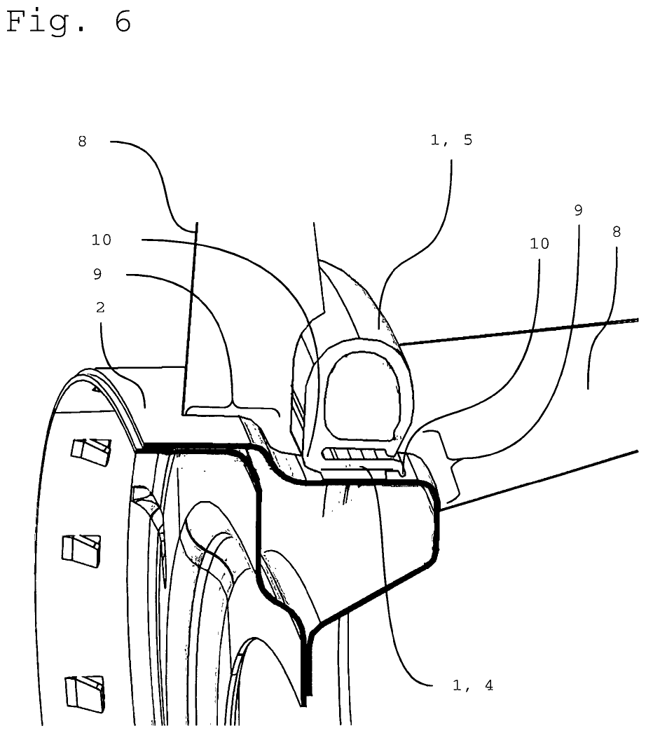

The fan-type sensors each sense the seal 1 and the component region 2 laterally adjacent to the seal 1 with its individual contour or geometry as shown in FIGS. 1 to 6. FIGS. 5 and 6 show these lateral sensing regions of the seal 1 and the component 2 or component region 2 as well as the spatial and planar features 9 of the component 2 or component region 2 and the spatial and planar features 10 of the seal 1, specifically on the right and on the left side. The wide regions where the component 2 and the seal 1 are sensed are apparent.

The method for automated position sensing of a seal 1 can be performed using the device according to the invention, wherein the at least one sensor 3 is arranged such that its main sensing direction 6 is oriented to be perpendicular to the running direction 7 of the seal 1 or of the component 2 or of the at least one component region 2 or to deviate from a perpendicular arrangement at an angle of up to 45 degrees and that the at least one sensor 3 senses the seal 1 and the component 2 or the at least one component region 2 at the seal 1 with a sensing range 8.

As shown in FIGS. 1 to 6, two sensors 3 are used, for example. These are laterally offset relative to each other and arranged in one plane and, as shown in FIGS. 1 to 4, attached to a support sheet or support whose ends are angled according to the main sensing directions 6 or the sensing ranges of the sensors 3 are angled, the support sheet being attached to a holder or a robot arm (not shown). Alternatively, these laterally offset sensors 3 may also be offset along the running direction 7 of the seal 1, i.e. not arranged in one plane.

The sensors 3 are oriented towards the dimensionally stable region 4 of the seal 1 and towards the spatial and planar features 9 of the component 2 or respective component region 2.

Depending on the seal and the geometry of the component 2, two or more sensors 3 are arranged such that the main sensing directions 6 or the sensing ranges 8 of the sensors 1 are oriented at an angle of about 85 degrees relative to each other as shown in FIGS. 1 to 6.

Depending on the seal 1 and the component 2, it is appropriate that the sensing ranges 8 of at least two sensors 3 overlap or overlie each other. However, depending on the type and geometry of the seal 1, it is not excluded that the overlap of the sensing ranges 8 is partly or fully shadowed by the seal 1.

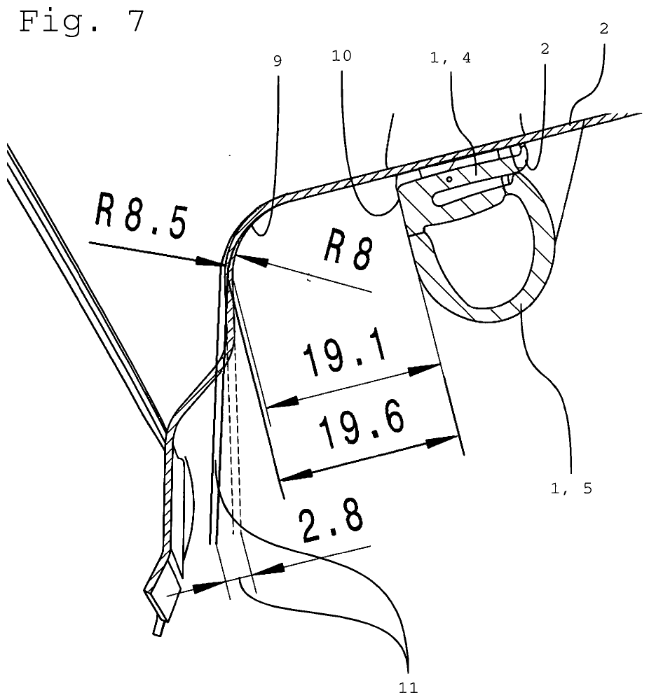

FIG. 7 shows a sectional view of a component 2 with a seal 1. Exemplary possible deviations 11 in the component geometry are shown, which would result in a faulty application of the seal 1 if not taken into account.

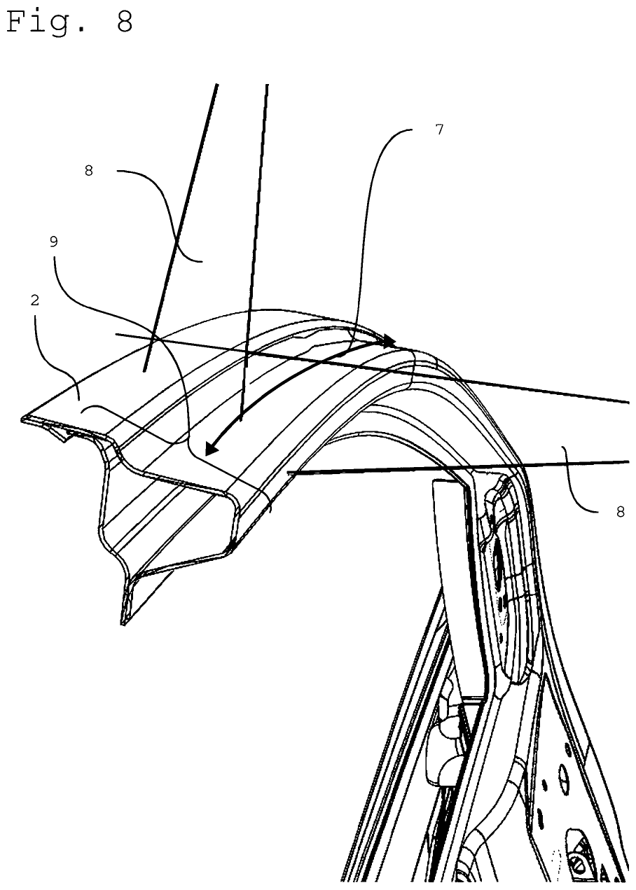

FIG. 8 shows that the sensors 3 also allow the component to be measured without the seal 1. In this case, the sensing ranges 8 of the sensors 3 overlap on the component 2 in the region to be sensed.

The method has been performed on a door derivative as component 2 as well as by means of robot-guided sensors 3 and also performed on a robot-guided component 2.

For example, the relative position of the seal 1 as a door seal on the door flange must be sensed as component region 2. The aim should be sensing the seal foot 4 relative to the door flange in order to largely exclude any manufacturing tolerance.

In that, the measuring method allows reliable measurement at defined measuring points. The method provides that measurement results can be produced and evaluated during a complete application, i.e. circumferentially. During this, the application can immediately be influenced.

A specific embodiment of the invention is currently based on so-called light section sensors which, using a known triangulation method, produce a laser spot which allows geometries to be sensed as a spatial, planar feature 9, 10 and resultingly outputs measurement results. The method provides that the sensing is also carried out using other technologies.

Principally, the scanning of the transitions from a radius to a straight line as a spatial or planar feature 9 on the respective component 2, of the respective component surface as component region 2 or as a spatial or planar feature 10 on the respective seal 1 or a borehole or any other spatial or planar particularity as a spatial or planar feature 9 of the component 2 as a preferred feature is suitable for determining the position of the seal 1. What feature is suited best for this purpose is preferably based on the availably geometry of the component 2 or any other spatial or planar particularity of the seal 1 and the angle of the sensor 3 relative to the respective feature. The width of seal 1 can be sensed in parallel, however, it is not drawn for the sake of clarity.

Sensors 3 recognize the dimensionally stable back of the door seal as well as spatial and planar features 9 of the door, such as e.g. the transitions from radii to straight lines. In order to ensure this more reliably, two sensors 3 are applied in the specific exemplary embodiment, looking perpendicularly, i.e. at a right angle, at the seal 1, and, on the other hand, are attached at a varying angle of about 50-70 degrees relative to the seal 1. The measurement set-up according to FIGS. 1 to 8 shows a schematic arrangement of the sensors 3 for inspecting the position of the seal 1 over two reference edges. A two-sensor arrangement is necessary due to the viewing perspective.

The distances are sensed as a simple profile measurement at the individual measuring points. In this, the measurement results of the left and right sensors 3 can by processed and computed synchronously.

For the specific exemplary embodiment, accessibility of the measuring points as well as measurement stability were investigated. The contour could be sensed at all measuring points, and stable profiles were delivered.

Monitoring the position of seal 1 is possible with three different concepts which differ in their degree of detail and the possibility to sense other defect causes/defect patterns.
A The simplest variant is the tracking of the absolute position of seal 1. This can also be done with only one sensor 3.
B To exclude uncertainties in the door handle position, the position of seal 1 can additionally be measured relative to a door geometry as a spatial, planar feature 9.
C To exclude uncertainties at the door geometry as the spatial, planar feature 9 itself, caused by manufacturing tolerances in the bodywork, the reference measurement can be extended to two door geometries per light section in the third step. For this purpose, two sensors are used. Depending on what sensor is selected, one sensor 3 may also be sufficient.

For example, one implementation is that the sensors 3 are guided around a fixed component 2 so that the sensors 3 need to be displaced during seal application or for position sensing such that the position of the seal 1 on component 2, component 2 being the door flange, for example, attached to a static holding system is measured relatively. During this, the component 2 is fixed in place for the application process and position sensing, and the components required for application and position checking are guided or moved past the component 2, e.g. a vehicle door, while said door is temporarily stationary.

Furthermore, one implementation is to make the attachment of sensors 3 rigid, i.e. no displacement of the sensors 3 is necessary during seal application, such that the position of the seal 1 on the door flange as component 2 can be measured relatively by means of a static measurement system. In this method, the component 2, e.g. the vehicle door, is guided or moved past the respective application and position sensing components while these are stationary, for application and position sensing.

In an exemplary embodiment, two sensors 3 are arranged in an appropriate set-up. In this set-up, the door as component 2, guided by a robot, is guided past a simulated application head and the measurement is made shortly before and after the application head, respectively. Since the sealing bead presses towards the inner door side when the seal 1 is applied, one of the sensors 3 is advantageously arranged at the inner door side at a 90-degree angle to the seal. To sense the seal foot 4 in a collision-free manner on both sides of the seal 1, the sensors 3 are arranged at a distance of 200 mm from the seal, for example. It is not imperatively required to make the sensors 3 follow the door movement by means of an additional robot, because shadowing does not occur in this setting and any measuring errors caused by oblique projection can be compensated also during processing.

In the specific exemplary embodiment, a measuring head LJ-V7200 from Keyence is used as a sensor 3. This exemplary measuring head, also designated as measuring probe, has a working principle where the laser beam is spread to project a line onto the surface of the object to be measured. The light reflected by the surface impinges on the receiver, e.g. an HSEa-CMOS. The displacement and shape are measured by the sensor 3 sensing the change in position and shape. The advantages of using a measuring head, also called measuring probe, over a camera system is that the measuring head provides calibrated height values and recalibration is not required. Furthermore, there are no adjustable components such as a lens or lens aperture. Depth of field is given over the entire sensing range. In addition, the measuring head is insensitive to extraneous light up to a type-related maximal ambient brightness.

Despite this, camera systems can be used as a sensor 3, which allow sequential and continuous measurement by means of three-dimensional sensing methods.

### LIST OF REFERENCE NUMERALS

1—Seal

2—Component, component region, vehicle door

3—Sensor

4—Dimensionally stable region, seal foot

5—Flexible profile

6—Main sensing direction

7—Running direction

8—Sensing range

9—Spatial, planar feature

10—Spatial, planar feature

11—Deviation

1. A method for automated position sensing of a seal (1) relative to a component (2) or at least one component region (2) during or after automated application of the seal (1), wherein the relative position of the seal (1) to the component (2) or to the at least one component region (2) is sensed by means of at least one sensor (3).

2. The method according to claim 1, characterized in that the position of the seal (1) is sensed relative to at least one geometry of the component (2) or of the at least one component region (2).

3. The method according to claim 1, characterized in that spatial and/or planar features (9) of the component (2) or of the at least one component region (2) are sensed.

4. The method according to claim 1, characterized in that spatial and/or planar features (10) of the seal (1) are sensed in at least some regions.

5. The method according to claim 1, characterized in that the seal (1) is sensed in a dimensionally stable region (4).

6. The method according to claim 1, characterized in that the cross-section of the seal (1), specifically of the flexible profile (5) of the seal (1), is changed.

7. The method according to claim 1, characterized in that position sensing is simultaneous, either circumferential or pointwise.

8. The method according to claim 1, characterized in that position sensing is performed as a distance measurement.

9. The method according to claim 1, characterized in that position sensing is performed using a triangulation method.

10. A device for performing the method for automated position sensing of a circumferential or sectionally running seal (1) by means of at least one sensor (2) relative to a component (2) or to at least one component region (2) during or after application of the seal (1), wherein the least one sensor (3) is arranged such that its main sensing direction (6) is oriented to be perpendicular to the running direction (7) of the seal (1) or of the component (2) or of the at least one component region (2) or to deviate from it at an angle of up to 45 degrees and the at least one sensor (3) with a sensing range (8) senses the seal (1) and/or the component (2) or the at least one component region (2).

11. The device according to claim 10, characterized in that with two or more sensors (3), the respective sensing ranges (8) of at least two of the sensors (3) are arranged in one plane.

12. The device according to claim 10, characterized in that with two or more sensors (3), at least two of the sensors (3) are arranged in an offset manner along the running direction (7) of the seal (1) or of the component (2) or of the at least one component region (2).

13. The device according to claim 10, characterized in that with two or more sensors (3), at least two sensors (3) are laterally offset relative to each other.

14. The device according to claim 10, characterized in that with two or more sensors (3), the main sensing directions (6) or the sensing ranges (8) of at least two sensors (3) are oriented parallel or at an angle of 1 to 90 degrees, preferably 50 to 70 degrees, relative to each other.

15. The device according to claim 10, characterized in that the sensors (3) are oriented towards the dimensionally stable region (4) of the seal (1) and/or towards spatial and/or planar features (9) of the component (2) or of the least one component region (2).

16. The device according to claim 10, characterized in that the sensors (3) are movable in place or can be guided around the component (2) or the least one component region (2).

17. The device according to claim 10, characterized in that the sensing ranges (8) of at least two sensors (3) overlap or overlie each other.
